(19) United States
(12) Patent Application Publication
(10) Pub. No.: US 2005/0199143 A1
(43) Pub. Date: Sep. 15, 2005

(54) Apparatus for decorating objects

(75) Inventors: Volker Steffen, Herford (DE); Dietrich Rodefeld, Hilter (DE)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Werner Kammann Maschinenfabrik GmbH

(21) Appl. No.: 11/002,056

(22) Filed: Dec. 2, 2004

(30) Foreign Application Priority Data
Mar. 12, 2004 (DE) 10 2004 012 078.1

(51) Int. Cl. B41F 17/00

(52) U.S. Cl. 101/35

(57) ABSTRACT

An apparatus for decorating objects which are carried by object carriers and are transported along a transport path through treatment stations of the apparatus includes an input station at which objects to be printed upon are introduced into the object carriers and a removal station at which the printed objects are removed from the respective object carriers. At spacings from the transport path are arranged at least one separating station at which the objects to be printed upon, which are stacked in a magazine, are individually removed, and at least one collecting station for the printed objects. The apparatus has a reciprocable first lift device arranged above the stack in the separating station and a first transport device for taking over the individual objects and transporting the separated objects towards the input station. The removal station has a reciprocable second lift device which transfers the removed objects to a second transport device for transporting the objects in a direction towards the collecting station.

### BACKGROUND OF THE INVENTION

The invention concerns an apparatus for decorating objects and more particularly an arrangement for moving objects to and from an apparatus for decorating objects.

One form of arrangement for moving objects to and from a decorating machine is to be found in U.S. Pat. No. 6,082,256 in which the apparatus disclosed is used for printing CDs. In general terms the objects are carried by object carriers and transported along a transport path through treatment stations. The arrangement includes an input station in which the objects to be printed are introduced into the object carriers and a removal station at which the printed objects are removed from the object carriers. Disposed at a spacing from the transport path is at least one separating station in which stacked objects to be printed are individually removed from a magazine, and at least one collecting station to which the printed objects are fed. The apparatus has at least one transport element for transporting the objects in a direction towards the input station and the collecting station, respectively.

Thus, the CDs to be printed upon, stacked in magazines, are introduced into the separating station in which the respective magazine disposed there is emptied, with the CDs being separated into individual items at the same time. The individual CDs are then transported in succession to the receiving or input station in which they are introduced into the object carriers for transporting the objects along the transport path through the individual treatment stations. The printed CDs are removed from the object carriers in the removal station and transported towards the collecting station in which the individual CDs are then stacked again in a magazine disposed at that station.

The throughput rate of the overall machine is determined by the respective throughput rates of the pieces of equipment which are required for separating the objects to be printed upon and for feeding them to the printing assemblies, and for moving the printed objects away from the printing assemblies again and collecting them. In a typical apparatus of the general kind outlined above, the configuration is such that the maximum throughput rate of the actual printing assembly cannot be put to use, because the operations of separating the respective objects to be printed upon and feeding them to the printing assembly and then moving them away from the printing assembly and collecting them take place at a rate which is below that which can be achieved by the actual printing assembly.

### BRIEF SUMMARY OF THE INVENTION

An object of the present invention is to provide an apparatus for decorating objects which can enjoy a marked improvement in the maximum object throughput rate.

Another object of the present invention is to provide an arrangement for moving objects to be printed upon to and from a printing assembly, in which the time required for handling the objects in connection with the operations of separating them and then transporting them to the printing assembly is reduced.

Yet another object of the present invention is to provide an object decorating apparatus in which the handling of printed objects, which are taken from a printing assembly and fed to a collecting station in which they are stacked in a magazine again, can be implemented more quickly and in a more rational manner.

Yet a further object of the invention is to provide an apparatus for decorating objects which while being adapted to give an increased throughput rate is of a simple structure and involves a straightforward mode of operation.

The foregoing and other objects are achieved by an apparatus for decorating objects which, carried by object carriers, are transported along a transport path through treatment stations, the apparatus including an input station at which objects to be printed are introduced into the object carriers and a removal station at which the printed objects are removed from the object carriers. Arranged at a spacing from the transport path is at least one separating station in which the objects to be printed, in a stack, are individually removed from a magazine in which they are accommodated, and at least one collecting station to which the printed objects are fed after the printing operation, transport devices being provided for transporting the objects towards the input station and the collecting station respectively. Disposed in the separating station is at least one reciprocable first lift device which removes the objects individually from the stack and a first transport device which takes over the individual objects from the first lift device and transports the objects towards the input station. Arranged at the removal station above the respective object carrier disposed there is at least one reciprocable second lift device, while a second transport device is provided for taking over the objects removed from the object carriers by the second lift device for transporting them towards the at least one collecting station.

As will be seen from the description hereinafter of a preferred embodiment of the invention, specific steps and measures in regard to the above-described operating procedures involving the objects are separated and thereby simplified, in such a way that specific items of the apparatus are associated with fewer functions, so that the individual steps to be performed and the items of equipment required for implementing them, as well as the co-operation thereof, can be suitably optimized. It will be seen that this applies in particular in regard to those operating movements in which the objects are lifted and are then transported to bridge over a spacing which involves a horizontal component. If the lifting action on the one hand, for example in connection with separation of the objects from a stack thereof into individual items, and subsequent further transportation thereof on the other hand, are separate steps, then it will be appreciated that the means used for that purpose can operate more quickly or at a higher cycle rate than is the case with the corresponding means of the prior apparatus referred to hereinbefore.

By virtue of the fact that the invention makes it possible for those operating means to be better adapted to the respective function attributed thereto, it is also possible to achieve a higher level of transparency in regard to operation of the machine and possibly also a simpler design configuration in the sense of a lower degree of complexity in the means used. Thus an important aspect of the invention provides that the two sets of operating movements referred to above, namely the lifting movement and separation of the objects and subsequent further transportation thereof, can at least partially overlap each other and accordingly can in part take place at the same time, whereas in prior apparatuses those movements could only occur in separate succession. At any event the increase in efficiency of the overall handling system, which can be achieved in accordance with the principles of the present invention, provides that the efficiency of the actual printing machine can be fully utilized without having to tolerate a substantial degree of complication in the apparatus structure and/or the operational procedures involved.

In actual fact, the use of conveyor belts and the linear transportation movement that this entails for the individual objects contributes to the transparency and accessibility of the apparatus. The use of conveyor belts as a transport element also has the advantage that the respective length thereof can be more or less freely selected. It is therefore possible to provide along the transport path afforded by the conveyor belt additional stations in which, for example, objects can be taken out of the handling system depending on the result of any checking procedures, for example in terms of checking the quality of the printed image applied to the respective objects.

The objects are handled in the system according to the invention using suction heads which can be connected to a reduced-pressure source and which pick up the respective object, hold it during the transport movement thereof and other handling procedures and then release it again. It will be noted that the use of suction heads for that purpose is generally known and can be found for example in U.S. Pat. No. 5,520,107, to which reference may accordingly be made for the purposes of incorporation of the content herein.

Further objects, features and advantages of the invention will be apparent from the description hereinafter of a preferred embodiment of the invention.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a highly diagrammatic plan view of an overall assembly comprising a printing machine and an apparatus according to the invention for feeding and removing objects;

FIG. 2 is a simplified view in section taken along line II-II in FIG. 1 showing a first transport bar assembly with a first lift device for objects to be printed;

FIG. 3 is a view in section taken along line III-III in FIG. 2;

FIG. 4 is a view in section taken along line IV-IV in FIG. 2;

FIG. 5 shows a partly sectional plan view of a region having stations in which objects to be printed are separated from each other;

FIG. 6 is a diagrammatic view of a region of the arrangement in which objects are transferred from the first transport bar assembly into object carriers of the printing machine;

FIG. 7 is a simplified view in longitudinal section taken along line VII-VII in FIG. 1 of a second transport bar assembly with a second lift device for printed objects;

FIG. 8 is a perspective side view of the second transport bar assembly;

FIG. 9 shows a perspective view of the second lift device on a larger scale; and

FIG. 10 is a view in section taken along line X-X in FIG. 9.

### DETAILED DESCRIPTION OF THE INVENTION

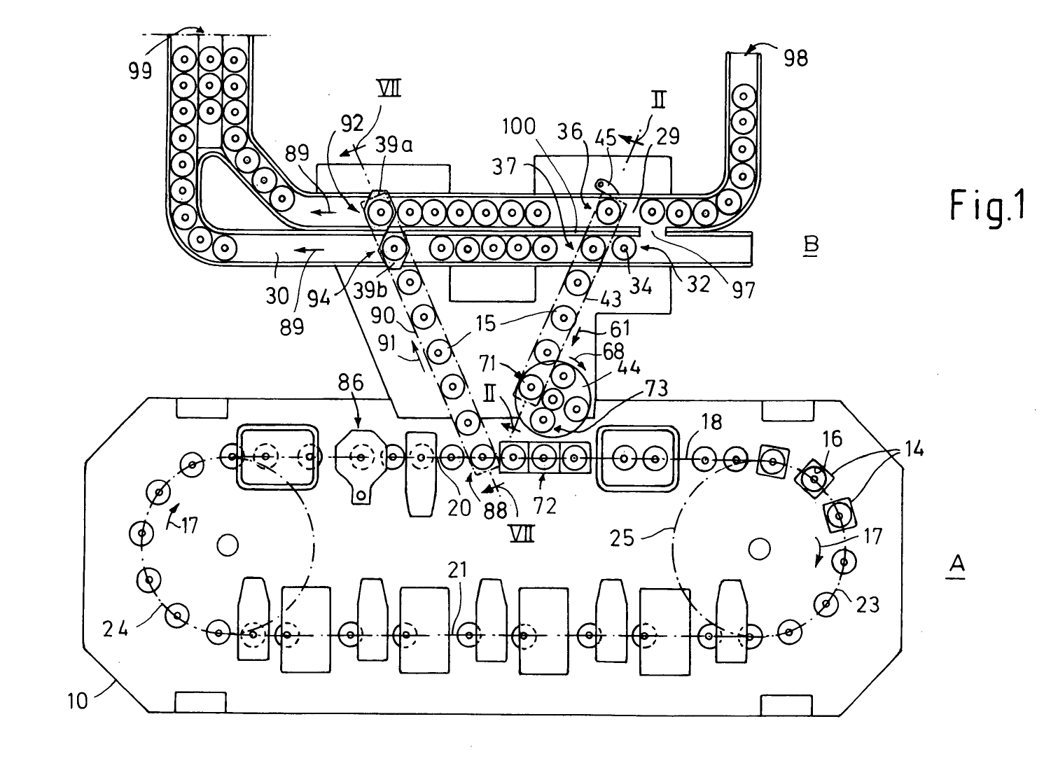

Referring first to FIG. 1, shown therein is an embodiment of the invention which includes a region generally identified at A having an actual printing machine 10 and a region B having devices for transporting objects to be printed to the printing machine 10 and for transporting printed objects away from the printing machine again to devices arranged downstream thereof, thus constituting the object-handling system.

The printing machine 10 serves for printing on flat objects, for example CDs, credit cards and the like. For the purposes of the description herein of the preferred embodiment of the invention the objects to be handled and printed upon will be in the form generally of CDs. The printing machine has a plurality of object carriers 14 which are in the form of carriages and each of which is provided at its top side with a receiver 16 for a respective object 15. The object carriers 14 are moved in the direction of arrow 17 shown in FIG. 1 along an endless transport path identified by reference 18 which comprises two linear portions 20, 21 which are disposed at a horizontal spacing from each other and two substantially semicircular portions 23, 24 interconnecting the two linear portions 20, 21.

Associated with each of the two linear portions 20, 21 of the transport path 18 is a transport screw (not shown) which provides for the transport movement of the object carriers 14 in the linear portions 20, 21. Associated with each of the two semicircular portions 23, 24 is a respective gear which is only indicated in FIG. 1 and denoted by reference numeral 25 and which rotates in a horizontal plane and which can rotate continuously or discontinuously. A possible design configuration for a machine of this nature is described and illustrated in U.S. Pat. No. 6,082,256, the disclosure of which is incorporated by reference into this application.

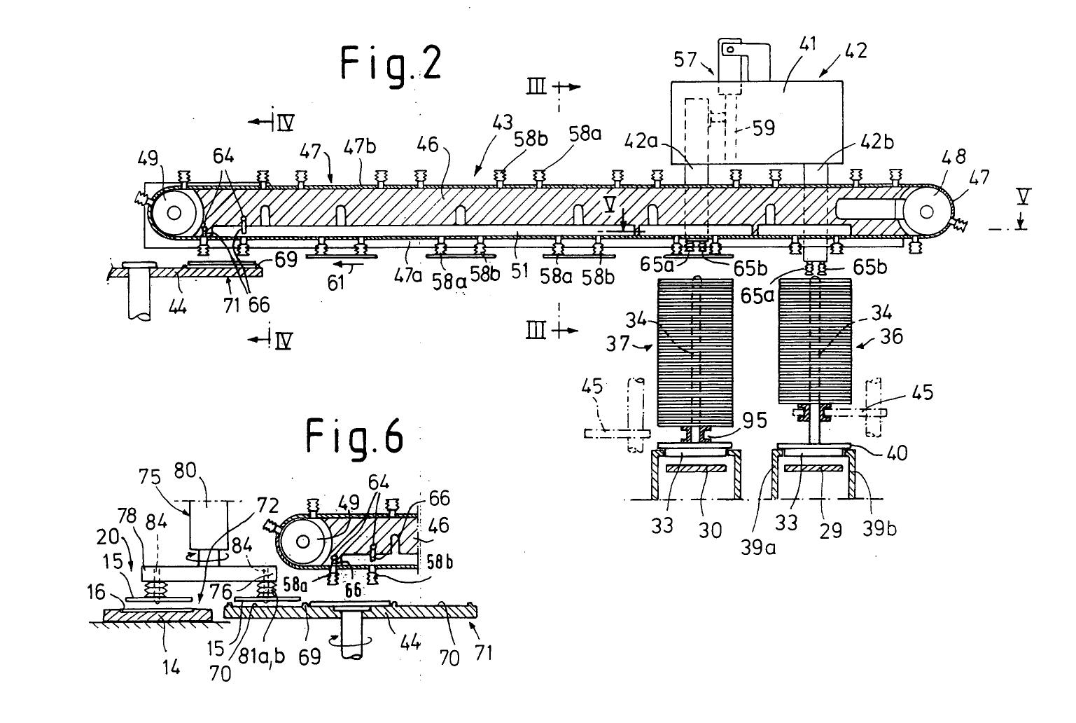

For transporting the objects 15 to be printed to the object carriers 14 of the printing machine and for transporting the printed objects 15 away from the printing machine 10 again, provided in the region B are transport means in the form of first and second curved conveyor belts 29, 30. When they are being transported on the conveyor belts 29, 30, the objects are arranged in the form of stacks in magazines 32 which in conventional manner are provided with a vertical holding and guide spindle indicated at 34 in for example FIG. 2. The spindle 34 of each magazine projects through the respective central hole in all of the objects such as the CDs forming the respective stack in a magazine 32. Each magazine has at its lower end a plate-like base indicated at 33 in FIG. 2 with a rim 40 on its top surface. Magazines of that nature are generally conventional and are known in terms of their specific design configuration, for which reason they do not need to be described in fuller detail herein.

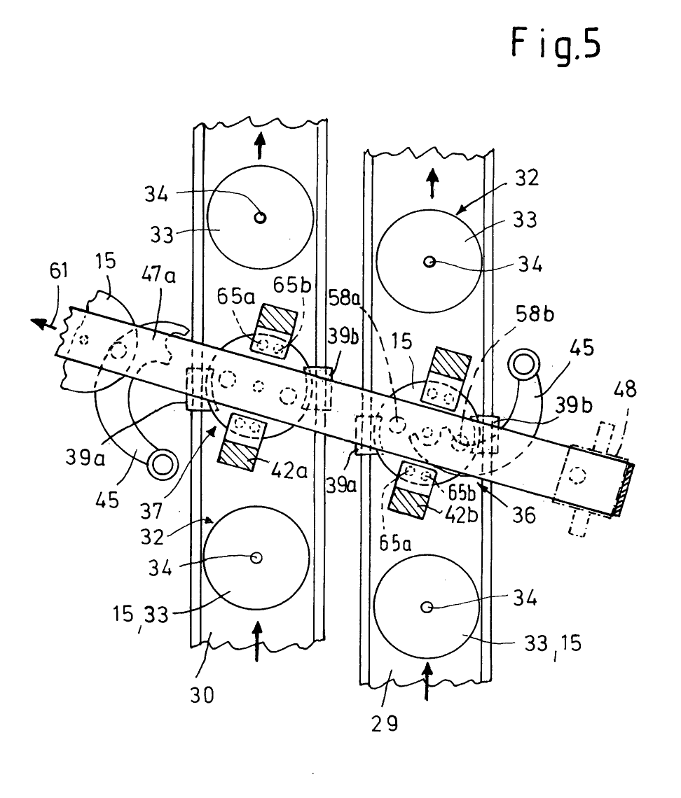

As the objects 15 are individually fitted into the receiver 16 of the object carriers 14, provided in the region of each of the two conveyor belts 29, 30 which are parallel over the major part of their extent are respective emptying or separating stations indicated at 36 and 37 and clearly identifiable in FIGS. 2 and 5, for separating the CDs in succession from their respective magazine and thus emptying the magazine. A respective magazine provided with a stack of CDs to be printed upon can be positioned in each respective separating station 36, 37. Provided in each of the two separating stations 36, 37, which are disposed in directly mutually juxtaposed relationship, is a two-part gripper device having gripper portions 39a, 39b which can be moved up and down jointly and which are adapted to the shape and the dimensions of the magazine base 33 and which have a closed position in which they engage under the projecting rim 40 at the top side of the base 33 after the magazine has been stopped by a movable abutment (not shown) disposed closely above the respective conveyor belt 29, 30.

After the gripper device has been closed and has engaged the magazine base 33, the gripper device is lifted so that the magazine is no longer in contact with the generally continuously circulating respective conveyor belt 29 or 30 and the stack of CDs in the magazine is aligned in relation to a lift portion 42a and 42b respectively, arranged above the magazine at a suitable spacing from the respective conveyor belt 29 and 30 respectively, of a lift or removal device 42 which is provided near the end, remote from the printing machine 10, of a first transport device generally indicated at 43 in FIG. 2, in the form of a transport bar assembly. The transport device 43 extends between the two separating stations 36, 37 on the one hand and a turntable indicated at 44 in FIGS. 2 and 6 on the other hand, the turntable 44 being provided with four receivers for respective objects 15 and being positioned at a short distance from the most closely adjacent linear portion 20 of the transport path 18, as can be clearly seen from FIG. 6.

The transport device 43 in the form of the transport bar assembly comprises a carrier identified by reference 46 in FIG. 2 which serves to mount a transport or conveyor belt which circulates in a vertical plane and which is in the form of a toothed belt, indicated at 47. For that purpose, disposed at each end of the transport bar assembly 43 are a drive roller and guide roller 48, 49 respectively, over which the toothed belt 47 is passed.

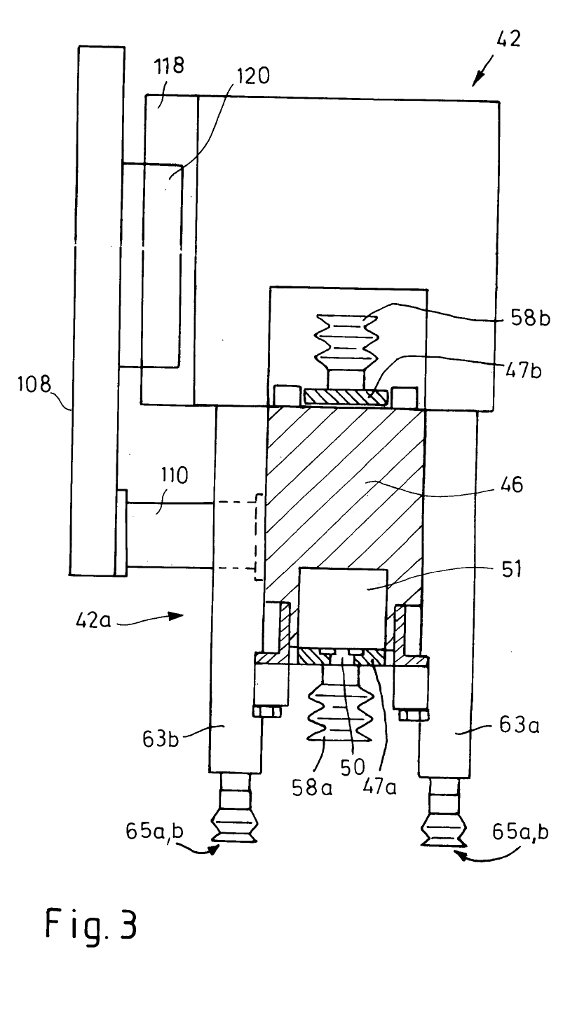

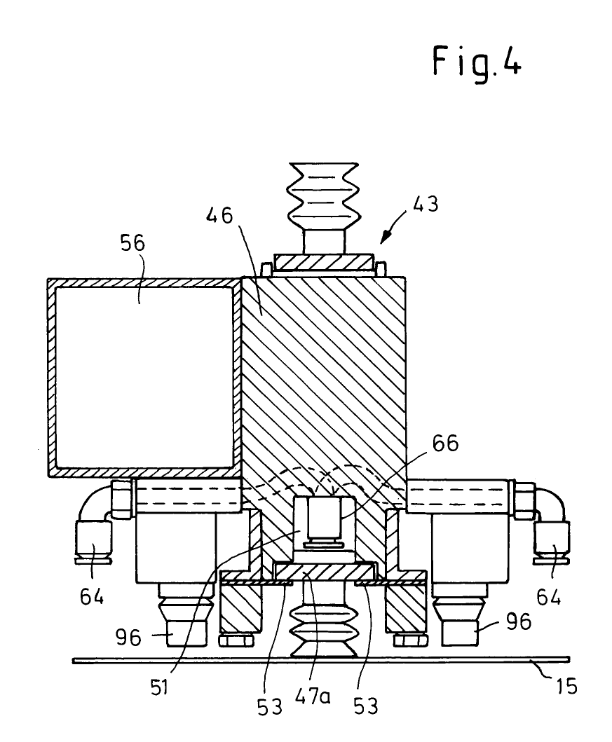

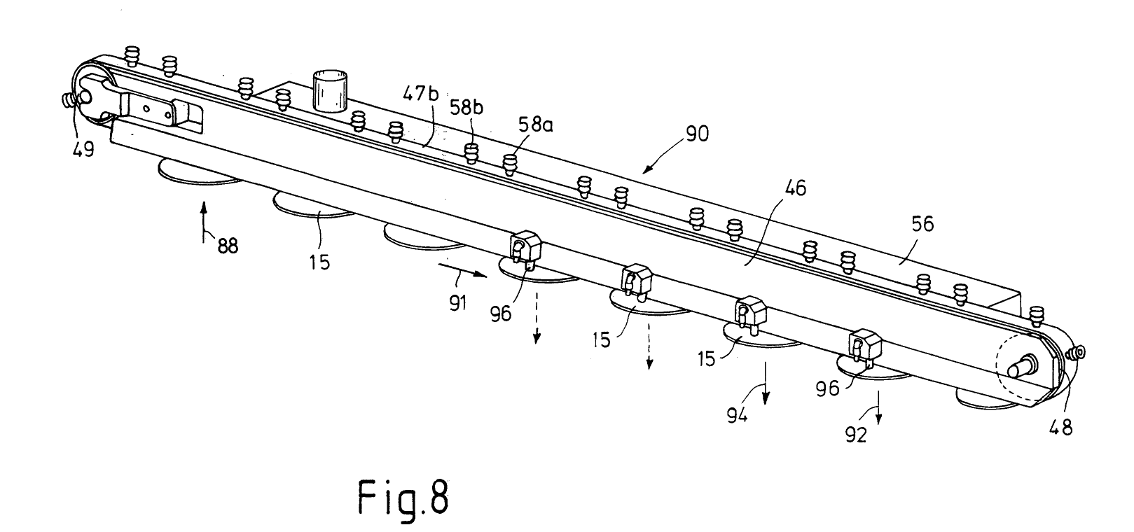

Reference may be made now to FIGS. 2 through 4 showing that the lower portion 47a of the toothed belt 47 closes a generally groove-shaped recess 51 which extends at the underside of the carrier 46 in the longitudinal direction thereof and which is connected to a reduced-pressure source. As can be seen from FIG. 4, arranged along the longitudinal extent of the carrier 46 at the lower boundary surface thereof and bearing against same along the edge regions of the lower portion 47a of the toothed belt 47 is a respective strip-shaped seal 53 which engages under the respective edge region of the lower portion 47a. It will be appreciated that the seals 53 are not shown in FIG. 3. The groove-shaped recess 51 is in communication by way of a plurality of communicating passages 54 with a reduced-pressure conduit 56 which extends along the carrier 46 of the transport bar assembly 43 and which can be clearly seen in FIG. 8 showing a second transport device 90 also in the form of a transport bar assembly.

Mounted to the toothed belt 47 along its longitudinal extent are suction heads 58a, 58b so arranged that they extend away from the carrier 46 and thus downwardly in the lower portion 47a and upwardly in the upper portion 47b. Those suction heads 58a, 58b are arranged in pairs in such a way that the spacing between two pairs of suction heads is smaller than the diameter of the object to be transported. Provided in the toothed belt 47 are holes 50 which are substantially aligned with the respective suction heads 58a, 58b and which form a communication between the recess 51 which is under a reduced pressure on the one hand and the respective suction head on the other hand, which projects with respect to the toothed belt 47 and is open at its end remote from the toothed belt 47. The toothed belt 47 circulates in the direction indicated by an arrow 61 in FIG. 2 in such a way that the CDs which are respectively picked up in the separating stations 36 and 37 are transported by the portion 47a to the turntable 44 in a manner still to be described hereinafter.

The two jointly actuable lift portions 42a, 42b of the lift device 42 which is mounted on the transport bar assembly 43 in such a way that it can be moved up and down are each substantially in the form of a downwardly open U-shaped frame, as can be clearly seen from FIG. 3, and are arranged in such a way that the transport bar assembly 43 with the toothed belt 47 extends between two limbs 63a and 63b of the respective U-shaped frame so that the U-shaped frame engages over the transport bar assembly 43 with the toothed belt 47. The spacing between the two lift portions 42a, 42b in the longitudinal direction of the transport bar assembly corresponds to the length of a transport stepping movement of the toothed belt 47 and the spacing between the two separating stations 36, 37 which are arranged in succession along the course of the transport bar assembly. Each of the two limbs 63a, 63b of each U-shaped frame is provided at its lower end with a pair of suction heads 65a, 65b which can be suitably connected to the reduced-pressure source which is present in any case. Each suction head, like also all other suction heads in the arrangement, is in the form of a short portion constituted by a bellows-shaped member.

Magazines which are disposed in the separating stations 36, 37 are alternately emptied by a procedure whereby the CDs in a respective magazine are successively removed from the stack therein. For that purpose, firstly the stack of CDs in each magazine is lifted by a lift arm 45 in such a way that the uppermost object or CD in the stack is at a level below the respective lift portion of the removal device 42, at which the pairs of suction heads 65a, 65b of that lift portion, in the lower position thereof, come into contact with the upwardly facing surface of that CD. In that case the lift arm 45 is in engagement with a sleeve which is indicated at 95 in FIG. 2 and which is carried slidably on the spindle 34 of the magazine 32 and carries the stack of CDs in the magazine. The lift arm 45 also performs the known function, after removal of the respective uppermost CD in the magazine, of moving the stack of CDs upwardly by the thickness of a CD in order in that way to move the respective following CD into a position in which it can be picked up by the pairs of suction heads 65a, 65b of the lift portion 42a, 42b.

More specifically, the operation of removing the respective CDs from the respective stack takes place in such a way that, to empty the magazine disposed for example in the separating station 36, the main frame 41 of the removal device 42 is displaced into its lower limit position, thereby entraining the U-shaped frame mounted directly thereto of the lift portion 42b associated with that station. In that lower limit position of the main frame 41 the pairs of suction heads 65a, 65b respectively disposed at the two sides of the transport bar assembly 43 come to bear against the respective uppermost CD in the stack and, by virtue of the suction effect, in the subsequent upwardly directed movement of the removal device 42, entrain that CD and lift it to such an extent that it comes out of engagement with the spindle 34 of the corresponding magazine and is caused to bear against the pair of suction heads 58a, 58b which are carried by the toothed belt 47 and which, at that time, are disposed above the magazine in the separating station 36.

As soon as contact occurs between the pairs of suction heads 58a, 58b and the CD and the CD is also supported by that pair of suction heads, the reduced pressure at the two pairs of suction heads 65a, 65b of the lift portion 42b is reduced or switched off so that the toothed belt 47 is now advanced by a transport step in a direction towards the turntable 44, thereby entraining the CD which is suspended from the toothed belt. The magnitude of the transport step is so selected that the CD already passes out of the region of movement of the lift device 42b in the course of that transport stepping movement and thus the lift device 42b can be moved downwardly again to take the next CD, before that transport stepping movement is concluded.

Transfer of the CD from the respective lift portion 42a, 42b to the toothed belt 47 is made easier by virtue of the fact that the upward movement of the CD, which is implemented by the respective lift portion, is restricted by the pair of suction heads 65a, 65b which are in the respective separating station. Admittedly, the bellows portions forming the respective suction heads are compressed somewhat under the effect of the upwardly moving CD, but that does not in any way change the fact that the two bellows portions represent an abutment which delimits the movement of the CD upwardly so that, with a suitably dimensioned lift movement on the part of the lift device, the suction heads 65a, 65b of the respective lift portion are positively released from the CD as soon as the reduced pressure acting on those suction heads 65a, 65b is markedly reduced. The abutment formed by the suction heads 65a, 65b thus represents an additional means for releasing the object from the suction heads 58a, 58b of the lift portion 42a, 42b.

FIG. 5 is a diagrammatic view showing the arrangement of the suction heads on the CD engaged thereby in plan at the moment of transfer thereof from the pairs of suction heads 65a, 65b of the lift device 42b of the separating station 36 to the pairs of suction heads 58a, 58b of the toothed belt 47.

The only purpose of providing the two separating stations is to ensure continuous charging of the toothed belt 47 and thus the printing machine 10 arranged downstream thereof with objects such as CDs even during the period of time in which an empty magazine is being changed for a full magazine bearing CDs to be printed upon. As however the station 37 is disposed downstream of the station 36 in the transport direction 61 for the CDs carried by the toothed belt 47, it is necessary to take precautionary measures to ensure that the CDs which are taken from the respective magazine in the station 36 and which must pass the other station 37 upon being transported in the direction 61 towards the turntable 44 do not experience any hindrance in the station 37. For that purpose the lift portion 42a associated with the station 37 is connected to the main frame 41 of the removal device 42, with the interposition of a pneumatically operated piston-cylinder unit 57, in such a way that the vertically reciprocable piston rod 59 of the piston-cylinder unit 57 is connected to the U-shaped frame of the lift portion 42a.

Looking now at FIG. 2, the piston of the piston-cylinder unit 57 is so operated that the piston rod 59 has moved into its upper limit position and in so doing has entrained the lift portion 42a which is now positioned relative to the main frame 41 at such a height that the lower boundaries of the suction heads 65a, 65b of the lift portion 42a are always above the level at which the CDs carried by the lower portion 47a of the toothed belt 47 are arranged. During emptying of the respective magazine at the station 36 therefore the lift portion 42a which is associated with the other station 37 and which is moved into an inoperative position idles. A corresponding consideration also applies in respect of the lift portion 42b upon emptying of the magazine disposed in the respective station 37 although here there is no need for the lift portion 42b to be positioned higher as, with the configuration involved here, objects suspended from the toothed belt 47 do not pass the separating or emptying station 36.

With the switch to the respective magazine at the station 37, which takes place immediately after emptying of the magazine at the station 36, the lift portion 42a is displaced downwardly by suitable actuation of the piston-cylinder unit 57 into its operative position in which the pairs of suction heads 65a, 65b which it carries assume the position in respect of height corresponding to the position in respect of height of the pairs of suction heads of the other lift portion 42b. The change in the position of the lift portion 42a relative to the main frame 41 can take place as soon as the last CD which has been removed from the magazine at the station 36 and which is hanging from the lower portion 47a of the toothed belt 47 has passed the stack disposed at the station 37. As the embodiment illustrated in the drawing provides that the two separating stations 36, 37 are spaced from each other by a transport step of the toothed belt 47, the first CD taken from the stack at the station 37 can directly follow the last CD which had been taken from the magazine at the station 36 so that all pairs of suction heads 58a, 58b of the toothed belt 47 are provided with CDs, in spite of the switch in the separating stations 36, 37. That is also because the transport path from the station 37 to an ejection station 71 above the turntable 44 is shorter by a transport step than from the other station 36.

During emptying of the magazine at the station 37, the magazine at the station 36 or the stack of CDs in that magazine is only lifted to such an extent that the uppermost CD in that stack does not come into contact with the suction heads of the lift portion 42b which is associated with the station 36 and which, as already mentioned above, is running idle.

When a switch is made from a magazine at the station 37 to the following magazine at the station 36, which has already been lifted by the gripper portions 39a, 39b, the stack thereof is lifted by the associated lift arm 45 so that the uppermost CD in the stack now comes into contact with the suction head of the lift portion 42b when the latter assumes its lower position. That affords the particularity that the last CD to be taken from the magazine at the station 37 and the first CD to be taken from the magazine at the station 36 are picked up at the same time by the respective lift portion 42a and 42b respectively and caused to bear against the pair of suction heads 58a, 58b on the transport belt 47, which are each in the respective station. Immediately thereafter the lift portion 42a is displaced upwardly into its inoperative position in the manner already described hereinbefore.

The embodiment of the invention illustrated in the drawing provides that the CD, which is taken over from the toothed belt 47 in the respective separating station 36 or 37, after four or five transport steps of the toothed belt, depending on the separating station 36 or 37 in which the CD was picked up, passes into the ejection station indicated at 71 in FIG. 6 in which the respective object is disposed above a respective one of four receivers diagrammatically indicated at 70, which are provided on the turntable 44 which is rotatable with a stepwise movement. Ejection of the CD from the respective pair of suction heads 58a, 58b of the toothed belt 47 is effected by removing or reducing the reduced pressure operative in the suction heads in the ejection station 71.

For that purpose, the transport bar assembly 43 is provided in the region of the ejection station 71 with feed conduits indicated at 64 for example in FIGS. 2 and 6 for compressed air which acts on the respective suction heads 58a, 58b at the ejection station 71 and thus eliminates the reduced pressure therein and acts on the CD which is suspended from the suction heads. In the embodiment illustrated in the drawing, disposed within the longitudinally extending recess 51 above the suction heads 58a, 58b disposed between two transport steps in the ejection station 71 is a respective vertically extending connection portion which is indicated at 66 in for example FIGS. 2 and 6 and which is connected to the feed conduit 64 and the outlet opening of which is disposed precisely above the hole 50 in the toothed belt 47 which forms the communication between the recess 51 and the adjoining suction head 58a or 58b respectively.

When the ejection station 71 is reached a compressed air surge is caused to act on the two suction heads 58a, 58b and that not only removes the reduced pressure for a short time but also causes an additional force to become operative, resulting in release of the CD from the two suction heads carrying it. In that situation the CD drops into the receiver 70 disposed therebeneath of the turntable 44. The CD is then moved by three transport steps each of 90° of the turntable 44 in the direction of the arrow 61 by way of two intermediate positions into a transfer station which is indicated at 73 in FIG. 1 and in which the receiver of the turntable 44 which has the respective CD and thus the respective CD itself are at a short distance from the input station 72 of the transport path 18 of the printing machine 10. In the two intermediate positions on the way from the ejection station 71 to the transfer station 73, the CD can be checked for example in respect of its identity and/or other criteria.

In the respective receiver 70 of the turntable 44 the CD which is ejected from the transport bar assembly 43 experiences a first orientation procedure. For that purpose each of the receivers of the turntable 44 is provided with a rim as indicated at 69 in for example FIGS. 2 and 6 which extends coaxially with respect to the receiver 70 around same and which at its inward side is of a conically bevelled configuration in such a way that the diameter of the rim 69 which thus extends over more than 180° of the periphery of the receiver 70 is of a smaller diameter at its lower boundary than at its upper boundary so that the CD as it drops from the transport bar assembly 43, in the course of its movement within the rim 69, is centered until it comes to bear against the upwardly facing surface defining the respective receiver 70 and is thus moved into a clearly defined position.

Referring now to FIG. 6, the spacing between the transfer station 73 of the turntable 44 and the input station 72 of the printing machine 10 is bridged by a transfer device indicated generally at 75 comprising first and second arms 76 and 78 which are reciprocable through 180° in a horizontal plane and which are displaced relative to each other through 180°, the arms 76, 78 being supported by a common vertical shaft 80. The shaft 80 is mounted in such a way that it can be moved up and down with the two arms 76, 78 over a short distance of for example between 15 and 20 mm. Near the end of each of the two arms 76, 78 at the underside thereof are two bellows portions each forming a respective suction head 81a, 81b which are provided at the underside with an opening and which can be connected to a reduced-pressure source (not shown).

In each of the two limit positions of the movement of the transfer device 75 one of the arms 76, 78 is disposed above the turntable 44 in the transfer station 71 and the other arm is disposed above the receiver 16 of the object carrier 14 which is respectively positioned at the input station 72 of the printing machine 10. Mounted on each arm 76, 78 between the two suction heads 81a, 81b on each arm is a vertical centering projection or bar 84 which tapers conically towards its free end and which, at its end region towards the respective arm 76, 78, is of a diameter which is so matched to the diameter of a central opening in a CD that, when the end region of the centering bar 84 is introduced into that opening, the peripheral surface of the centering bar 84 bears against the edge of the opening with a fit which excludes movement of the CD transversely with respect to the longitudinal axis of the centering bar.

When the transfer device 75 is in its lower position the two suction heads 81a, 81b on the arm 76 which is in the transfer station 73 are pressed against the top side of the CD which is disposed in the respective receiver 70 of the turntable 44, which is positioned at the transfer station 73. In that case the bellows portions forming the suction heads 81a, 81b are compressed somewhat, as also in all other situations. In the course of the preceding downward movement of the transfer device 75, the centering bar 84 has been introduced into the central opening in the CD in such a way that the above-described conical configuration thereof and its close fit within the opening in the CD provides that the CD is definitively accurately oriented so that it assumes a properly defined position.

In a subsequent short upward movement of the transfer device 75 the CD is lifted out of the receiver 70 by the reduced pressure which at least now acts on the suction heads, and in the course of the following rotary movement through 180° the CD is moved into a position above the receiver 16 of the object carrier 14 which at that time is at the input station 72. In the following downward movement of the transfer device 75 the CD is deposited in the receiver 16 of the object carrier 14 which is at the station 72 and which at that time also assumes a defined position.

The object carrier 14 is provided at its top side with a suitable opening for receiving the centering bar 84 in the downward movement of the transfer device so that the CD cannot experience a change in its properly defined position even upon being deposited in the receiver 16. The receiver 16 of the object carrier 14 is also connected to a reduced-pressure source so that, at the moment at which the CD is deposited in the receiver 16, a suction force acts on the underside of the CD and, after the reduced pressure acting on the two suction heads 81a, 81b is switched off, the transfer device 75 can be lifted again in order to move the centering bar 84 out of engagement with the CD which is held in position during the following transport movement through the treatment stations and during the treatment operations carried out therein, by the reduced pressure which is operative in the respective receiver 16.

Directly following the upward movement of the transfer device 75, by which the CD which has been deposited in the receiver 16 of the object carrier 14 had been released, the transfer device 75 is turned back again through 180°, in which case the respective other arm 76 or 78 transposes the following CD from the transfer station 73 into the receiver 16 of the next object carrier 14 which in the meantime has moved into the input station 72. In order to guarantee the level of precision with which the respective CD is positioned in the receiver 16 without involving a high level of technical complication and expenditure, it may be appropriate for the reciprocating rotational movements of the transfer device 75 to be restricted by an abutment which clearly determines the limit position of the arms 76 and 78 respectively in the input station 72 relative to the receiver 16 of the respective object carrier 14.

After the objects, such as the CDs being considered here, have passed through the treatment stations of the printing machine 10, which can also include a station as indicated at 86 in FIG. 1 in which the print image applied to the respective CD is checked in respect of its quality, the CDs which are disposed in the respective object carriers 14 pass successively into a removal station 88 in which they are successively removed from the printing station 10. For that purpose the assembly has a second transport device in the form of a transport bar assembly as indicated at 90 in FIG. 1, the basic construction of which corresponds to that of the first transport bar assembly 43 so that identical parts are also denoted by the same reference numerals. There is therefore no need for the transport bar assembly 90 to be described in full detail again at this juncture, as reference may be directed to the description hereinbefore of the transport bar assembly 43. It will be noted that in particular FIG. 1 shows that the second transport bar assembly 90 extends without the interposition of further pieces of equipment between the removal station 88 in the transport path 18 of the printing machine 10 and the two conveyor belts 29, 30 for the magazines.

The second transport bar assembly 90 is also provided with a longitudinal carrier 46 and a toothed belt 47 on which suction heads 58a, 58b are disposed in the same manner. The drive conditions are reversed insofar as here, in the case of the transport bar assembly 90, the toothed guide roller 48 is driven as it is the lower portion 47a of the toothed belt that moves in the direction indicated by the arrow 91.

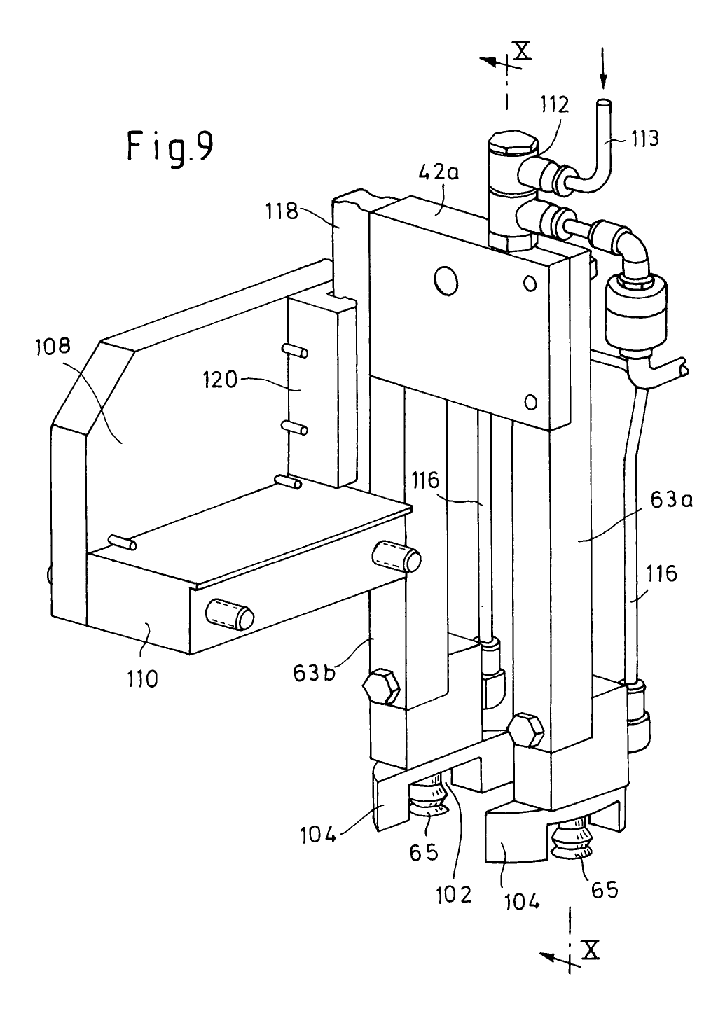

Disposed near the end of the transport bar assembly 90, which is towards the printing machine 10, is a lift device 42 which, as a departure from the corresponding lift device 42 which co-operates with the first transport bar assembly 43, has only one lift portion 42a. In this respect reference may be directed to FIG. 9 showing that the lift portion 42a is also in the form of a generally U-shaped frame and is arranged in the manner described hereinbefore with reference to the transport bar assembly 43. In the case of the lift portion 42a shown in FIG. 9, however, it carries only one respective suction head 65 at each of the two limbs 63a, 63b of the U-shaped frame structure.

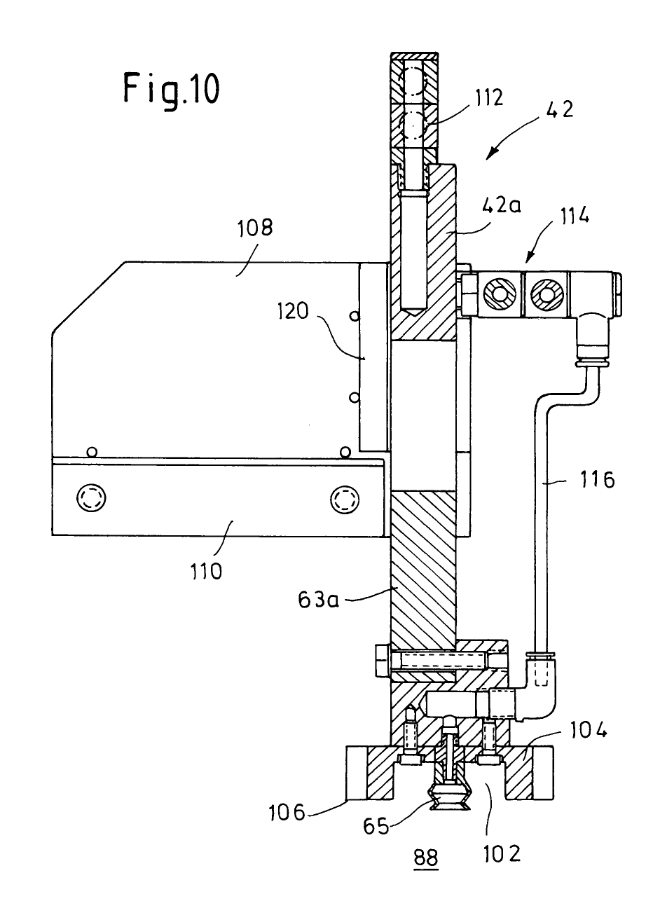

Each of the two suction heads 63a, 63b is arranged within a recess 102 on an abutment portion 104, as can be clearly seen from FIGS. 9 and 10. The two abutment portions 104 are each mounted at the lower end of the respective limb 63a, 63b of the U-shaped frame assembly, in such a way that the respective recess 102 is open downwardly and the associated suction head 65, in the non-loaded condition, that is to say without an object carried thereby, projects somewhat downwardly with respect to the lower boundary surface 106 of the respective abutment portion 104, as can be seen in particular from FIG. 10.

The lift device 42 is fixed above the receiver 16 of the respective object carrier 14 at the removal station 88, by means of a side plate indicated at 108 in FIG. 9 and FIG. 10 and a bracket 110 on the transport bar assembly 90. As soon as a respective object carrier has moved into that station the lift portion 42a is displaced downwardly until the two suction heads 65 come to bear against the CD disposed in the receiver. In that situation the two suction heads 65 are compressed somewhat, with the consequence that the CD comes to bear with its upper boundary surface against the lower boundary surface 106 of each of the two abutment portions 104 and thus adopts a clearly defined position which is also retained during the following upward movement of the lift portion 42a as the pressure of the ambient air presses the CD against the two abutment portions 104.

Before the beginning of the upward movement the reduced pressure acting on the CD in the receiver 16 of the object carrier 14 had been switched off. In the course of the upward movement in this case also the CD is caused to bear against the pair of suction heads 58a, 58b on the lower run 47a of the toothed belt 47, which is respectively disposed in the region of the lift device 42, and can in this case also act as an abutment for limiting the lift movement of the CD. Then, in the manner already described hereinbefore in connection with the operation of separating the CDs to be printed upon into individual items, the printed CD is carried exclusively by the pair of suction heads 58a, 58b after the reduced pressure acting in the pair of suction heads 65 of the lift device 42 had been cut off.

Thus, in this case also, similarly to the operation of separating the CDs to be printed upon as described hereinbefore, the advantage attained here is that the movement involved in lifting the CD, in this case out of the receiver 16 of the object carrier 14, on the one hand, and the transport movement for that CD in a substantially horizontal plane, in this case towards a collecting station which is still to be described hereinafter, on the other hand, take place separately, so that it is possible to achieve a considerable increase in the throughput rate of the machine overall.

In order to cause the reduced pressure within the bellows portion forming each of the two suction heads 65 to be operative the lift portion 42a is provided with a connection indicated at 112 in FIGS. 9 and 10 for a hose indicated at 113 in FIG. 9 which forms a communication with a reduced pressure source (not shown) and which is so flexible that it can follow the movements of the lift portion 42a. From the connection 112, the reduced pressure is distributed to the suction heads 65 of the two limbs 63a and 63b of the U-shaped frame structure.

Provided for that purpose is a distributor member 114 from which extends a respective line 116 going to the respective suction head 65. The distributor portion 114 is also provided with a branch (not shown) which can be communicated with the outside atmosphere by way of a valve (also not shown) in order in that way to remove the reduced pressure in the suction heads 65 as quickly as possible, for example upon transfer of the CD carried by the suction heads 65 of the lift portion 42a to the suction heads 58a, 58b of the toothed belt 47. The valve of the above-mentioned branch is thus opened as soon as the CD comes to bear against the respective pair of suction heads 58a, 58b in the course of the upward movement of the lift portion 42a, and possibly even fractions of a second earlier, in order to speed up the removal of the reduced pressure in the conduit system, at the respective end of which is arranged a suction head 65. At the latest at the beginning of the following downward stroke movement of the lift portion 42a the communication with the ambient atmosphere is then closed by closing that valve.

It will be appreciated at this juncture that the lift portions 42a, 42b of the lift device 42 carried by the first transport bar assembly 43 can be of a corresponding structural configuration, in which respect each of the two lift portions 42a and 42b may have its own vent valve associated therewith in order to minimise the volume of the systems which must each be subjected to a reduced pressure or normal pressure or even an increased pressure.

In addition the means described hereinbefore with reference to FIGS. 9 and 10 may also be provided on the transfer device 75 in order to suitably control the pressure conditions in the suction heads 81a, 81b thereof.

The toothed belt 47 of the second transport bar assembly 90 is also moved stepwise in order to transport the CD picked up in the removal station 88 by the respective pair of suction heads 58a, 58b in a direction towards the collecting station 92 and 94 respectively. The lift device 42a can be moved downwardly again to remove the next CD from the following object carrier 14 which in the meantime is disposed in the removal station 88 as soon as the last CD has left the region of movement of the lift device in the direction of the arrow indicated at 91 in FIG. 1.

The use of only one suction head on each limb 63a, 63b of the U-shaped frame structure of the lift device 42a, in comparison with the two suction heads in relation to the lift portions 42a, 42b of the first transport bar assembly 43, is possible for the reason that the CDs are disposed individually in the respective receiver 16 of the object carriers 14 and thus removal thereof from the respective receiver takes place substantially more easily than the operation of lifting an individual CD from a stack, as is necessarily the case in the two separating stations 36, 37. As the printed CDs are removed without exception only in the one removal station 88 in succession by being lifted out of the respective object carrier 14 disposed there, it is also only necessary to provide one lift device 42 for removal of the objects.

Associated with the other end region of the transport bar assembly 90, being therefore the upper end region in FIG. 1, are first and second collecting stations 92, 94 for the CDs to which printing has been applied. The collecting stations 92, 94 are also used alternately in order to be able to further operate continuously even when a full magazine is being replaced by an empty magazine. Similarly to the arrangement of the separating stations 36, 37, the collecting station 92 is associated with the conveyor belt 29 and the collecting station 94 is associated with the conveyor belt 30 so that the two stations 92, 94 are positioned along the lengthwise extent of the transport bar assembly 90.

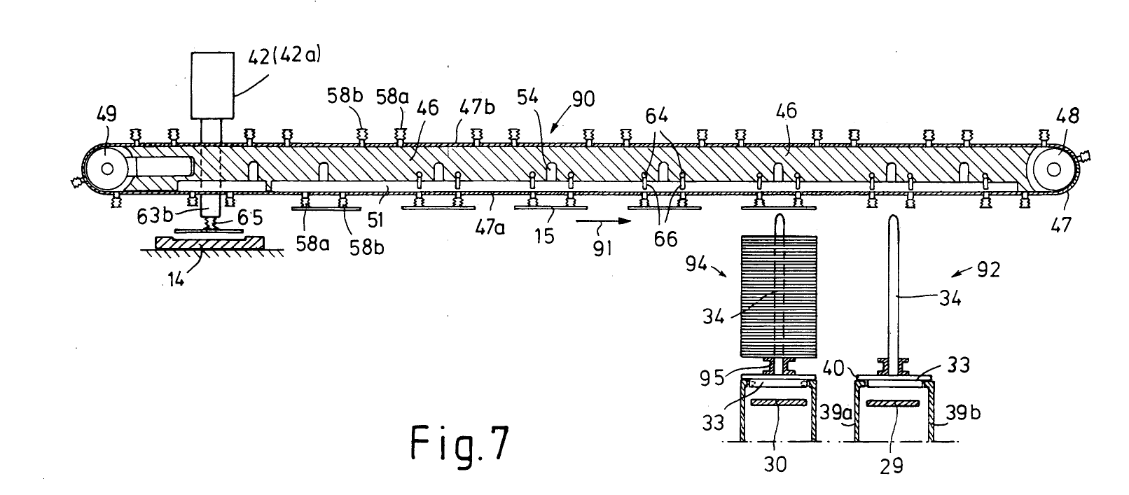

Depending on which of the two collecting stations 92, 94 is being used at a respective time, the CDs which are suspended from the pairs of suction heads 58a, 58b are transported stepwise either to the collecting station 92 or to the collecting station 94. In the embodiment as illustrated in the drawing in the condition shown in FIG. 7 the collecting station 94 is provided with a magazine 32 which is almost completely filled while an empty magazine is disposed in the collecting station 92. In a similar procedure to that already described hereinbefore with reference to the separating stations 36, 37, the two magazines are each engaged at their base 33 by the two portions 39a, 39b of a respective gripper and lifted to such an extent that the upper end of the respective spindle 34 is disposed at a short distance below the CD which is carried on the toothed belt 47 in a condition of being suspended therefrom in the respective collecting station, in the illustrated case being the collecting station at the left in FIG. 7 as indicated by 94. The CD held above the magazine in the respective station 92 or 94 by the toothed belt 47 is oriented with its opening aligned with the spindle 34 of the respective magazine so that, when the CD is released by the pair of suction heads 58a, 58b carrying them and drops downwardly, the CD comes into engagement with the spindle 34 and slides downwardly along it until it either rests on the respective uppermost CD in the stack or, if it is the first CD in the station 92, it drops downwardly until it rests on the sleeve 95 which carries the stack as it is being formed.

As soon as the magazine 32 disposed in the station 94 is filled with CDs the magazine is moved downwardly by a suitable lowering movement of the portions 39a, 39b of the gripper until the base 33 is carried on the conveyor belt 30. After that, an abutment which is disposed closely above the conveyor belt 30 and against which the base 33 of the magazine 32 laterally bears is removed so that the magazine filled with printed CDs can be transported away by the conveyor belt 30.

FIG. 7 shows the situation shortly before the switch from the collecting station 94 to the collecting station 92. The magazine 32 which is still empty is already disposed in the collecting station 92 in the position in which it will receive the printed CDs. It is therefore readily possible for both magazines to simultaneously assume the upper limit position as the upper end of the respective spindle 34 is admittedly disposed in that position only at a small spacing below the path of movement of the CDs which are suspended from the suction heads 58a, 58b, but it does not hinder the movement of the CDs.

Accordingly upon each switch in magazine it is possible to achieve a seamless transition between the respective magazines disposed in each of the two collecting stations, especially as the only essential measure which is still required in that respect involves controlling the influence of the reduced pressure acting on the suction heads 58a, 58b of the toothed belt 47 during the transport movement for the purposes of ejecting the CD, in such a way that, at any event after a switch from the collecting station 94 to the collecting station 92, the increase in pressure which is required for ejection of the CD, within the respective pair of suction heads 58a, 58b, only takes place in the collecting station 92 and thus the reduced pressure required for holding the CDs to the toothed belt 47 is maintained when passing the collecting station 94. It will be appreciated that it is also possible for the measures required for the increase in pressure in the pairs of suction heads 58a, 58b, for ejection of the CDs, to be only ever implemented in the station which is being respectively used for stacking the CDs.

In order to guarantee that, after an increase in pressure in the respective pair of suction heads 58a, 58b disposed in the ejection station 71 or one of the collecting stations 92, 94 respectively, the CD also actually comes free from the respective suction heads, the illustrated embodiment includes at those three stations additional means for releasing the CDs from the suction heads 58a, 58b. This involves, at the two sides of the respective transport bar assembly 43 and 90 respectively, in the proximity of the lower boundary thereof, ejectors indicated at 96 in FIGS. 4 and 8, which are disposed in pairs in such a way that a respective ejector is provided at each side of the respective transport bar assembly 43, 90 and the two ejectors of a pair are in mutually opposite relationship.

The ejectors are in the form of small, vertically reciprocable pistons which are displaceable downwardly against the force of a spring, for example under the action of compressed air, and when they so move press with their lower end against the upper surface of the respective CD and thus displace it downwardly in a controlled manner by a distance which is sufficient in any event to release the CD from the pair of suction heads 58a, 58b supporting it. Those ejectors 96 can be suitably controlled, for example in dependence on a program, or in some other fashion, for example in dependence on the transport movements of the respective toothed belt 47. The symmetrical arrangement of the two ejectors 96 in relation to the respective CDs ensures that, during the short distance which is to be covered until the CD is disposed in the respective receiver 70 of the turntable 44, which is at the ejection station 71, or comes into engagement with the spindle 34 of the respective magazine 32, the CD remains in the alignment required for that purpose in relation to the receiver 70 or the spindle 34 respectively.

Further ejectors 96 can also be provided at the transport bar assembly 90 between the removal station 72 and the collecting station 94 which is first in the transport direction 91 for the CDs, in order to remove from the transport flow for example CDs which, when the printed image thereon is checked at the station 86 of the printing machine 10, have been found to be defective. In that case, depending on the result of the checking operation in the checking station indicated at 86 in FIG. 1 or in another checking station, for example for checking identity, the pairs of suction heads respectively disposed in the appropriate position between two transport steps of the toothed belt 47 are subjected to the action of compressed air and the associated ejectors 96 are actuated, in which respect magazines for receiving those rejected CDs can also be provided beneath the ejectors for receiving the CDs. Actuation with compressed air can be effected for example in the manner described with reference to the ejection station 71, using compressed air connections 64 and connecting portions 66.

The magazines 32 which are filled with the CDs to be printed are put on to the upper run of the conveyor belt 29 at the input end 98 thereof, more specifically including those magazines which are emptied in the separating station 37 of the second conveyor belt 30. Attention should be directed at this juncture to FIG. 1 showing that the two conveyor belts 29, 30 extend in parallel and immediately mutually juxtaposed relationship over a substantial part of their length. In the transport direction 99 of the two conveyor belts 29, 30 immediately upstream of the two separating stations 36, 37 the guide rails extending between the two conveyor belts 29, 30 are provided with an aperture 97, the length of which in the transport direction indicated by the arrow 89 is slightly greater than the largest diameter of a magazine 32. That aperture 97 in the guide rails 98 permits each second magazine with unprinted objects to be pushed from the conveyor belt 29 transversely on to the conveyor belt 30 so that the conveyor belt 30 is loaded with magazines by way of the conveyor belt 29. That affords a simplification insofar as all magazines with objects to be printed upon only need to be put on to the same conveyor belt at one location.

The transverse movement of each second magazine from the conveyor belt 29 onto the conveyor belt 30 is effected automatically by a pusher which is reciprocable transversely with respect to the transport direction indicated by the arrow 89 in the region of the aperture 97 and which, in dependence on a program or any operating conditions of the assembly, implements transverse displacement of a respective magazine on to the conveyor belt 30.

After the respective magazine disposed in the separating station 36 or 37 respectively has been emptied it is lowered on to the respective conveyor belt 29 or 30 again by suitable actuation of the gripper members 39a, 39b and is entrained by the respective conveyor belt in the direction of the respective collecting station 92 or 94 before, after a residence time in an accumulation space between a respective separating station and an associated collecting station, it passes into the respective collecting station and is there filled with printed objects in the manner already described hereinbefore. The filled magazine is transported towards the discharge end 99 of the respective conveyor belt, where it is then removed from the region B.

All movements of the various transport arrangements in the region B are mechanically derived from a central drive assembly. Thus the stepping transmission for the turntable 44 is driven by way of a belt drive from the central electric motor of the apparatus. The stepwise movement of the conveyor belt 47 of the first transport bar assembly 43 is derived from the stepwise transport movement of the turntable 44. The stepwise movement of the toothed belt 47 of the second transport bar assembly 90 is in turn derived from the movement of the toothed belt 47 of the first transport bar assembly 43. The swing transmission for the transfer device 75 is driven by the shaft of the stepping transmission. Disposed on the continuous shaft of the swing transmission are three cams which, by way of a respective coupling rod, produce the lift movements of the lift devices 42 at the first and second transport bar assemblies 43 and 90 as well as the lift movements of the transfer device 75.

Mounted at the lift portions 42a and 42b is at least one respective guide bar which is indicated at reference 118 in FIG. 3 and which slides in at least one shoe indicated at 120 in FIG. 3 mounted as a guide means to the fixed region of the lift device 42. The coupling rod which transmits the lift movements engages the respective lift portions 42a and 42b or the main frame structure 41 carrying same.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. An apparatus for decorating objects comprising:
a transport path,
treatment stations along the transport path,
object carriers movable along the transport path for transporting objects along the transport path through the treatment stations,
an input station at which objects to be printed are introduced into object carriers,
a removal station at which printed objects are removed from the object carriers,
at a spacing from the transport path at least one separating station in which stacked objects to be printed are individually removed from a magazine and at least one collecting station to which the printed objects are fed,
at least one transport means for transporting the objects in a direction towards the input station and the collecting station, respectively,
at least one reciprocable first lift device arranged at the separating station for removing objects individually from the stack and a first transport device for taking individual objects from the first lift device and for transporting the objects in a direction towards the input station, and
at least one reciprocable second lift device arranged at the removal station above a respective object carrier therein and a second transport device for taking objects removed from the object carriers by the second lift device and for transporting same in a direction towards the at least one collecting station.

2. The apparatus as set forth in claim 1,
wherein each lift device includes at least one suction head for engaging an object and a connection from the suction head to a reduced pressure source.

3. The apparatus as set forth in claim 1,
wherein the first and second transport devices each include a carrier, a circulating transport belt carried on the carrier, at least one suction head on the transport belt for engaging an object, and a connection from the suction head to a reduced pressure source.

4. The apparatus as set forth in claim 2,
wherein the first and second transport devices each include a carrier, a circulating transport belt carried on the carrier, at least one suction head on the transport belt for engaging an object, and a connection from the suction head to a reduced pressure source.

5. The apparatus as set forth in claim 4,
wherein in a position of one of the lift devices an object carried by at least one suction head thereof is also in operative contact with the at least one suction head of the respective transport device,
and further including control means for controlling the suction heads of the lift device and the transport device in respect of their suction effect, such that the object is transferred from the at least one suction head of the lift device to the at least one suction head of the respective transport device.

6. The apparatus as set forth in claim 4,
wherein the transport belt circulates in a vertical plane and is narrower than the greatest extent of an object transversely with respect to the longitudinal extent of the transport belt and the at least one suction head of the respective lift device is arranged to be moved upwardly and downwardly beside the transport belt,
such that in the position of the lift device in which an object is transferable from the lift device to the at least one suction head of the transport belt the at least one suction head is substantially at the height of the at least one suction head of the transport belt for receiving the object.

7. The apparatus as set forth in claim 3,
wherein the suction heads of the transport belt are mounted thereto in paired relationship,
such that the two suction heads of a pair substantially symmetrically engage the same object.

8. The apparatus as set forth in claim 3, including
means for controlling the transport belt for stepwise advance thereof in dependence on the movements of the lift device in such a way that at the end of a transport stroke of the lift device at least one suction head of the transport belt is at the separating station.

9. The apparatus as set forth in claim 2,
wherein each lift device includes at least one frame structure having first and second vertical limbs which laterally embrace the transport device and which each carry at least one respective suction head.

10. The apparatus as set forth in claim 2, including
a controller operable to alleviate the reduced pressure acting on a respective object carried by the respective at least one suction head at the end of the respective transport movements to release the object.

11. The apparatus as set forth in claim 10, including
additional means for separating an object from the at least one suction head carrying same.

12. The apparatus as set forth in claim 11,
wherein the means are pneumatic means.

13. The apparatus as set forth in claim 11,
wherein the means are mechanical means.

14. The apparatus as set forth in claim 3, including
an elongate carrier mounting the transport belt and having an underside with at least one recess closed by the lower run portion of the transport belt transporting the objects, and
a connection from the recess to a reduced pressure source,
the transport belt at locations at which the suction heads are mounted having holes forming a communication between the recess and the respective suction head carried by the transport belt.

15. The apparatus as set forth in claim 14, including
a conduit having a mouth opening at positions at which a respective object disposed there is released by the at least one suction head, and
a connection from the conduit to a compressed air source,
such that when the transport belt is stationary the mouth opening is disposed approximately above a hole in the transport belt, which is associated with the at least one suction head which is at the respective position.

16. The apparatus as set forth in claim 7,
wherein the suction heads of a pair are arranged in succession in the transport direction.

17. The apparatus as set forth in claim 1, including
a transfer station in proximity to the input station,
an intermediate conveyor downstream of the first transport device in the transport direction, the conveyor having receivers for the objects and operable to bring a respective object in at least one transport step into the transfer station, and
a transfer device movable between the respective receiver of the intermediate conveyor which is at the transfer station and the receiver of the respective object carrier which is at the input station.

18. The apparatus as set forth in claim 17,
wherein the transfer device includes at least one arm rotatable about a vertical axis and provided with at least one suction head for holding an object to be transposed from the transfer station into the input station.

19. The apparatus as set forth in claim 17, including
means for moving the transfer device upwardly and downwardly.

20. The apparatus as set forth in claim 18,
wherein the transfer device has first and second arms each provided with at least one suction head near a respective free end thereof.

21. The apparatus as set forth in claim 18,
wherein in proximity to its free end the at least one arm has a downwardly extending positioning bar of cross-sectional dimensions adapted to those of a hole in an object, such that in the transfer station upon the insertion of the positioning bar into the hole the object is oriented in relation to the bar and is inserted in the oriented position into the receiver of a respective object carrier.

22. The apparatus as set forth in claim 1, including
first and second separating stations arranged in succession in a longitudinal direction of the first transport device,
wherein the lift device includes first and second lift portions each operatively associated with a respective separating station, and means for controlling the first and second lift portions for alternate operation thereof to transfer objects received thereby to the common first transport device.

23. The apparatus as set forth in claim 22, including
a lift device structure carrying the lift portions, and
means for heightwise displacement of at least one of the lift portions with respect to the lift device structure.

24. The apparatus as set forth in claim 3, including
first and second collecting stations which are arranged in succession in the longitudinal direction of the second transport device and which are operable alternately,
such that objects transported by the second transport device are released in one of the collecting stations which is respectively in operation from the respective at least one suction head of the transport belt.

25. The apparatus as set forth in claim 1, including
first and second conveyor belts for feed transport of magazines filled with objects to be printed upon and for transporting away the magazines filled with printed objects,
a separating station associated with each of the conveyor belts,
a collecting station for collecting printed objects, the collecting station being disposed downstream of the separating station in the transport direction of the respective conveyor belt,
wherein the first transport device extends linearly in oriented relationship with the separating stations above same and the second transport device extends linearly in oriented relationship with the collecting stations above same, and
a portion of the respective conveyor belt operable to receive empty magazines between each separating station and the respective collecting station associated with the same conveyor belt.
